(19) United States
(12) Patent Application Publication
(10) Pub. No.: US 2003/0116147 A1
(43) Pub. Date: Jun. 26, 2003

(54) A CRANKCASE VENTILATION SYSTEM FOR AN INTERNAL COMBUSTION ENGINE

(76) Inventor: Staffan Rengmyr, Goteborg (SE)

(21) Appl. No.: 10/248,141

(22) Filed: Dec. 20, 2002

(30) Foreign Application Priority Data
Dec. 21, 2001 (EP) 01850220.3

(51) Int. Cl. F02B 25/06

(52) U.S. Cl. 123/572

(57) ABSTRACT

### Abstract of Disclosure

The invention relates to an internal combustion engine (1), comprising a cylinder block (2), a cylinder head (3) mounted upon the cylinder block (2), and a crankcase (5) containing a supply of oil for lubricating the engine (1). At least one crankcase ventilation passage (11) extends from the crankcase (5), at a position which is above the oil level, and through the cylinder block (2) and the cylinder head (3). A three-way termination (17) in the cylinder block (2) connects the crankcase ventilation passage (11) to at least two cylinders (7).

### Background of Invention

Field of the Invention

The present invention relates to a multi-cylinder internal combustion engine having a cylinder block, a cylinder head mounted upon the cylinder block, a crankcase containing oil for lubricating the engine, and at least one crankcase ventilation passage extending from the crankcase at a position which is above the oil level and through the cylinder block and the cylinder head.

Background of the Invention

Internal combustion engines are provided with a crankcase ventilation arrangement to reduce the over pressure in the crankcase resulting from the reciprocating movement of the pistons in the cylinders. The crankcase defines a space beneath the cylinders and above the oil level in the crankcase. In this space, air may be mixed with oil and moisture, which is prevented from reaching the ambient air when the crankcase is ventilated. Also a small portion of the working gases escaping from the combustion chamber past the piston rings to the crankcase, referred to as blow-by, are also prevented from escaping from the engine. For this reason the crankcase ventilation arrangement is connected to the intake system, which in turn is connected to the cylinders and the combustion chambers. Any oil, moisture, and blow-by gases are ventilated through the crankcase ventilation arrangement and are in this way recycled through the combustion process.

A known crankcase ventilation arrangement for an internal combustion engine is disclosed in US 4,493,295. Two vertically arranged ventilation passages extend from the crankcase, through the cylinder block and the cylinder head and end under the camshaft cover. Oil return channels extend parallel to the ventilation passages and are separated from the ventilation passages. When the ventilation passages are separated from the oil returning channels, oil returning from the cylinder head is prevented from being mixed with the ventilated air.

However, due to the reciprocating movement of the pistons in the cylinders, pressure pulsations are generated in the crankcase and into the crankcase ventilation arrangement. The pressure pulsations lead to a loss of engine power and to an excessive amount of oil drops or oil particles being removed from the crankcase by the pulsating air. As a result, fuel and oil consumption increase thereby affecting engine out emissions.

### Summary of Invention

According to the present invention, the above-mentioned problem is solved by an internal combustion engine mentioned in the introduction of this specification, wherein a three-way termination in said cylinder block connecting said crankcase ventilation passage to at least two cylinders.

By connecting the crankcase ventilation passage to at least two cylinders, the pulses created by one of the pistons in one of the cylinders will be equalized when the gases are free to flow into the other cylinder and vice versa thereby solving the problem caused by the pressure pulsations. Thereby, engine power is increased and fuel and oil consumption is reduced.

According to another aspect of the present invention the three-way termination is located near bottom dead center (BDC) of piston travel in the cylinder. As a result, the pulsating air created by the piston's downward movement is directed immediately into the ventilation passage via the three-way termination.

### Brief Description of Drawings

The invention will now be described by way of example and with reference to the accompanying drawings in which:

Figure 1 is an exploded, perspective view of an internal combustion engine according to the present invention;

Figure 2 is a cutaway, perspective view of a cylinder block of the engine in Figure 1;

Figure 3 is a plan view of the cylinder block shown in Figure 2; and

Figure 4 is a section view of the cylinder block according to an aspect of the present invention.

### Detailed Description

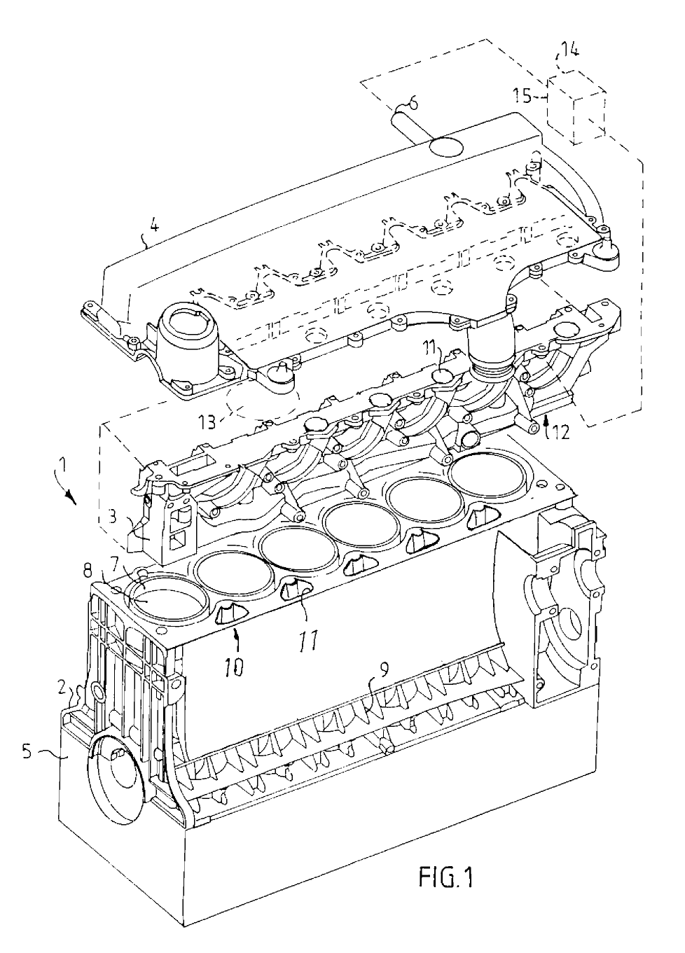

Figure 1 is an exploded view, in perspective, of an internal combustion engine 1 according to the present invention. The internal combustion engine 1 is in this embodiment an inline-6 cylinder engine. Engine 1 comprises a cylinder block 2, a cylinder head 3 mounted upon the cylinder block 2 and a camshaft cover 4 arranged above the cylinder head 3. Cylinder head 3 is only partly shown in Figure 1. In the bottom part of the cylinder block 2 a crankcase 5 is formed. The crankcase 5 defines a space containing lubricating oil for the engine.

The cylinder block 2 is provided with six cylinder bores 7 in which reciprocating pistons 8 are arranged. Also the cylinder head 3 is provided with cylinder bores 7. On the outside of the cylinder block 2 reinforcement ribs 9 are arranged.

The engine 1, according to the present invention, is provided with a crankcase ventilation arrangement 10 to reduce the over pressure in the crankcase 5 resulting from the reciprocating movement of the pistons 8 in the cylinders bores 7. The cylinder block 2 according to the embodiment disclosed in Figure 1 is provided with five vertically arranged crankcase ventilation passages 11. Due to the manufacturing process of the cylinder block 2, preferably casting, the vertical passages 11 are tapered. Each vertical passage 11 extends from the crankcase 5 at a position which is above the oil level in the crankcase and through the cylinder block 2 and the cylinder head 3. Each passage emerging from the cylinder head 3 under the camshaft cover 4 arranged above the cylinder head 3.

The crankcase ventilation arrangement 10 is connected to the intake system 12 of the engine 1 which in turn is connected to cylinders 7 and combustion chambers 13. In this way, any oil moisture and blow-by gases ventilated through the crankcase ventilation arrangement 10 are recycled through the combustion process. Preferably, cover 4, arranged over cylinder head 3, is provided with an opening 6 for connecting the space under cover 4 to intake system 12 of engine 1. According to the embodiment in Figure 1 the engine is provided with a turbocharger 14 and the ventilation arrangement 10 is connected to the inlet 15 of turbocharger 14.

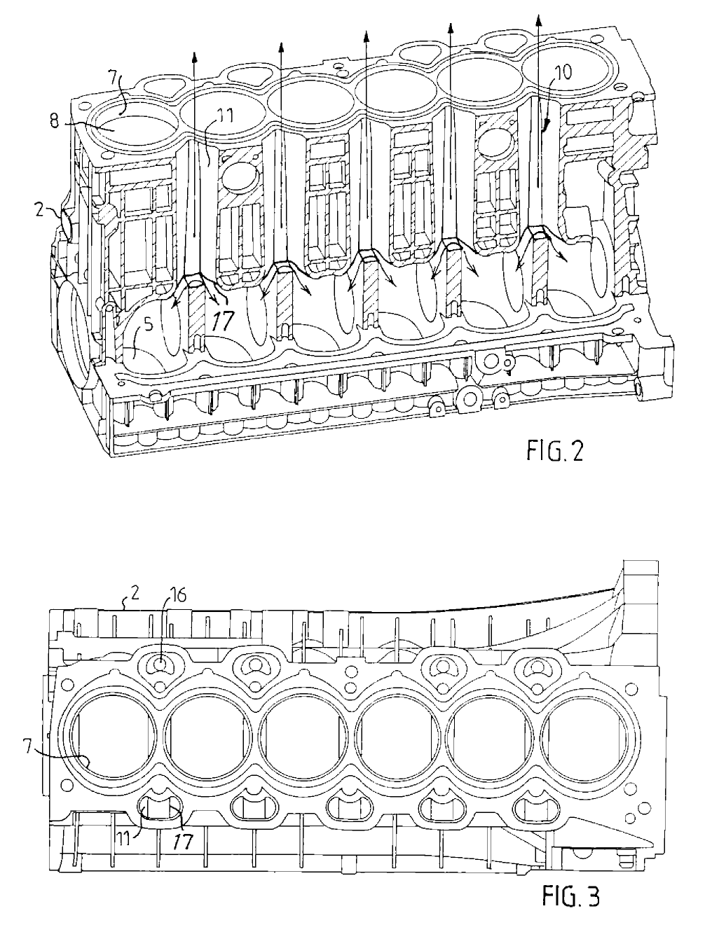

As mentioned above, the reciprocating movement of pistons 8 in cylinders 7 generates pressure pulsations in crankcase 5 and into the crankcase ventilation arrangement 10. The pressure pulsations lead to a loss of engine power and to an excessive amount of oil drops or oil particles being removed from the crankcase 5 and through the ventilation arrangement 10 by the pulsating air in the crankcase 5. As a result, fuel and oil consumption increase and emissions from the engine 1 can be increased. According to the present invention this problem is solved by a three-way termination 17 in said cylinder block 2 connecting said crankcase ventilation passage 11 to at least two cylinders 7. This is disclosed in Figure 2.

In Figure 2 a cylinder block 2 according to the present invention is disclosed in a partly cutout view in perspective. Five vertical ventilation passages 11 are arranged in the cylinder block 2. Each ventilation passage 11 is arranged substantially between and offset to two cylinders 7, so that each ventilation passage 11 is connected by the three-way termination 17 to two cylinders 7. This connection is illustrated with the double directed arrows in Figure 2. Since each passage 11 is connected to two cylinders 7 all cylinders 7 are connected to each other. Therefore, pulses created from one of the pistons 8 in one of the cylinders 7 will be equalized when the air is free to flow into the other cylinders 7 and vice versa. Preferably, the three-way termination 17 is located near the bottom dead center (B.D.C) of the cylinder 7. As a result the pulsating air created by the underside of the pistons 8 will be directed immediately into the ventilation passages 11 via the three-way terminations 17. Preferably, the number of ventilation passages 11 is less than or equal to the number of cylinders 7. As an example, six ventilation passages 11 are arranged in the cylinder block 2 when there are six cylinders 7 present in the engine. However, in an inline-six cylinder engine the two central pistons 8 are moving together side-by-side and a ventilation passage 11 is not appropriate, since the two central pistons 8 cannot compensate each others movement. Hence, only four ventilation passages 11 are used in an inline-six cylinder engine of this example. In an inline-five cylinder engine are four ventilation passages 11 and in an inline-four cylinder engine there are three or two ventilation passages 11.

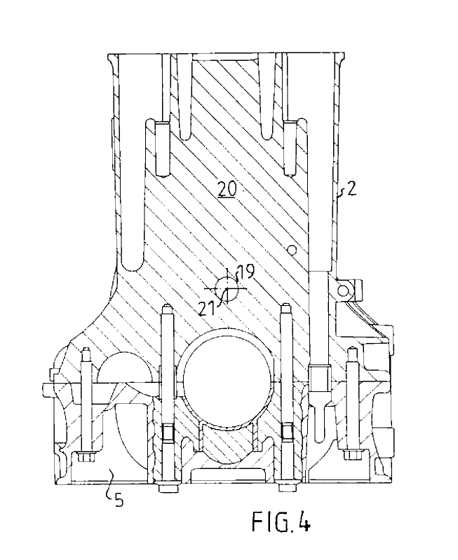

Figure 3 is a view from above the cylinder block 2 according to the present invention. From this figure, it is evident how the vertical ventilation passages 11 are arranged substantially between and offset from the cylinders 7. On the opposite side of the row of cylinders 7, four oil drainage passages 16 are arranged in block 2. The oil drainage passages 16 extend essentially parallel to the ventilation passages 11 and are in this way separated from the ventilation passages 11. As a result, separated oil, returning from the cylinder head 3 and into the crankcase 5, is prevented from mixing with the ventilated air in the ventilation passages 11.

According to a second embodiment disclosed in Figure 4 openings 19 are arranged in the cylinder walls 20 in a position beneath a bottom dead center (BDC) location of the pistons (not shown in Figure 4) in the cylinder 7. Preferably, the openings 19 have a common centerline 21, which extends in the same direction as the row of cylinders 7. The openings reduce or eliminate the pulsations in the ventilated air.

Hereinafter, the function of the crankcase ventilation arrangement 10 in the internal combustion engine 1 according to the present invention is described. The reciprocating movement of the pistons 8 in the cylinders 7 generates a pulsating over pressure in crankcase 5. The over pressure creates an airflow in the three-way terminations 17, which connect the vertical passages 11 to the cylinders. The air flows upwards in the vertical passages 11 in the cylinder block 2 and into the vertical passages 11 formed in the cylinder head 3. Also, pulses created from one of the pistons 8 in one of the cylinders 7 will be equalized when the air is free to flow into the other cylinder 7 and vice versa. Hence, the pressure pulses in the crankcase 5 and in the vertical passages 11 are reduced or eliminated. The air in the vertical passages 11 flows into the space under the camshaft cover 4 and further out of the opening 6 arranged in the wall of the cover 4. From the opening 6, the air is guided to the intake system 12 of the engine 1 via the turbocharger 14.

I claim:

Claims

1. A crankcase ventilation system for a multi-cylinder internal combustion engine, the engine having a cylinder block, a cylinder head mounted upon the cylinder block, a crankcase containing a supply of oil for lubricating the engine, a least one crankcase ventilation passage extending from the crankcase at a position above the oil level and through the cylinder block and the cylinder head, the system comprising: a three-way termination in the cylinder block connecting the crankcase ventilation passage to at least two cylinders.

2. The crankcase ventilation system of claim 1 wherein said three-way termination is located near a position in the cylinder beneath a bottom dead center location of a piston corresponding to the cylinder.

3. The crankcase ventilation system of claim 1 wherein the ventilation passage extends essentially parallel to the cylinders.

4. The crankcase ventilation system of claim 1 wherein the ventilation passage is tapered with an increasing size in a direction from the crankcase to the cylinder head.

5. The crankcase ventilation system of claim 1 wherein at least two ventilation passages are arranged in the cylinder block and the cylinder head.

6. The crankcase ventilation system of claim 1 wherein the ventilation passage is located substantially between two cylinders.

7. The crankcase ventilation system of claim 1 wherein a total number of ventilation passages is less than or equal to the number of cylinders.

8. The crankcase ventilation system of claim 1, further comprising at least one oil drainage passage arranged in the cylinder block and cylinder head wherein said oil drainage passage is separated from said ventilation passage.

9. The crankcase ventilation system of claim 1 the ventilation passage emerges from the cylinder head under a camshaft cover arranged above the cylinder head.

10. The crankcase ventilation system of claim 1 wherein the ventilation passage is connected to an intake system of the engine via a camshaft cover, said camshaft cover being arranged above the cylinder head.

11. The crankcase ventilation system of claim 1 wherein the ventilation passage is connected to an intake system of the engine via an inlet of a turbocharger, said turbocharger being coupled to said intake system of the engine.

12. The crankcase ventilation system of claim 1, further comprising: openings arranged in cylinder walls of said at least two cylinders connecting between said at least two cylinders.

13. An internal combustion engine having a plurality of cylinders contained in a cylinder block, a cylinder head mounted upon the cylinder block, a crankcase containing lubricating oil for the engine, at least one crankcase ventilation passage extending from the crankcase at a position which is above a level of the oil in the crankcase and through the cylinder block and the cylinder head wherein a three-way termination in the cylinder block connects the crankcase ventilation passage to at least two of said plurality of cylinders.

14. The engine of claim 13 wherein the ventilation passage is located substantially between two cylinders.

15. The crankcase ventilation system of claim 13 wherein a total number of ventilation passages is less than or equal to the number of cylinders in the engine.
